(19) United States
(12) Patent Application Publication
(10) Pub. No.: US 2013/0173501 A1
(43) Pub. Date: Jul. 4, 2013

(54) Decorative Clip and Multiple Interchangeable Ornamental Pendant Accessory System

(71) Applicant: Carole Anne Wrubel, Detroit, MI (US)

(72) Inventor: Carole Anne Wrubel, Detroit, MI (US)

(21) Appl. No.: 13/339,156

(22) Filed: Dec. 28, 2011

(51) Int. Cl. A44C 25/00; G06Q 90/00

(52) U.S. Cl. 705/500; 63/40

(57) ABSTRACT

A clip with two elongated members each having a forward end defining a gripping portion; a rear end defining a pinching portion and a centrally disposed pivot portion about which each memnber pivots. A resilient member in the form of a spring acts to bias the gripping portions into abutment with each other and to hold the elongated members together. The invention is to provide a simple arrangement for attaching and wearing a jewelry accessory item to one's clothing and gear and to allow the wearer the ability to easily add, remove, trade, exchange, collect, or replace ornamental pendants and the like to the decorative clip.

### BACKGROUND OF THE INVENTION

A principal objective of the invention is to provide a novel ornamental accessory system. The invention is to provide a simple arrangement for attaching and wearing a jewelry accessory item to one's clothing and gear and to allow the wearer the ability to easily add, remove, trade, exchange, collect, or replace ornamental pendants and the like to the decorative clip.

### BRIEF SUMMARY

The present invention relates to a decorative clip in which multiple interchangeable ornamental attachments such as pendants, charms, jewelry pieces, stud earrings, lapel pins, tie pins, collector pins and the like are connected in a manner as desired by the wearer with certain prescribed possibilities. The decorative clip may be secured in various ways to safely and securely grip delicate or thin material such as a camisole or a bra strap and to grip securely to relatively thick and rigid material such as a hat brim.

### BRIEF DESCRIPTION OF SEVERAL VIEWS OF DRAWINGS

FIG. 1 is a front elevational view of a completed clip and ornamental pendant assembly embodying the invention;

FIG. 2 is a side elevational view illustrating the clip of the invention; and

FIG. 3 is a frontal elevational view of the lower clip member illustrating the internal resilient member and gripping portion areas without padding or coating

### DETAILED DESCRIPTION OF THE INVENTION

Hereon in, pendants, charms and jewelry items to be assembled as interchangeable ornamental suspended attachments on said decorative clip will be referred to as ornamental pendants.

Hereon in, decorative clips, manufactured from metal and/or plastic, will be referred to as clips. It is desirable that the clip assembly contain the following traits:
a) A clip with multiple connectors to accept detachable ornamental pendants
b) A clip with a hole or holes to fasten, attach or lace strings, ties, ribbons, ornamental chains and the like
c) A clip with multiple connectors on one or both sides allowing the clip to be worn as a right or left hand jewelry article
d) A clip coated with synthetic polymer material or the like to protect wearer's clothing and skin
e) A clip coated with synthetic polymer material or the like to provide anti-slip/anti-slide properties
f) A clip coated with synthetic polymer material or the like to provide different decorative colors, patterns and designs.
g) One or more detachable ornamental pendant(s) with a permanent pendant connector
h) One or more detachable ornamental pendant(s) with a detachable connector

Having described the invention in detail, those skilled in the art will appreciate that modifications may be made of the invention without departing from the spirit of the inventive concept herein described.

Decorative Clip: A clip with two elongated members each having a forward end defining a gripping portion, a rear end defining a pinching portion and a centrally disposed pivot portion about which each member pivots. A resilient member in the form of a spring acts to bias the gripping portions into abutment with each other and to hold the elongated members together.

There has been described and illustrated herein a preferred embodiment of a wearable accessory decorative clip. While a particular embodiment of the invention has been described, it is not intended that the invention be limited thereto, as it is intended that the invention be as broad in scope as the art will allow and that the specification be read likewise. Thus, while no particular resilient members have been disclosed, it will be appreciated that a resilient member in the form of a spring will be utilized.

Ornamental Pendants: A clip is intended to display multiple ornamental pendants. Ornamental pendants are to be suspended from the clip. Ornamental pendants are intended to be gifted, traded, exchanged, bartered, purchased and collected. Ornamental pendants are of various shapes and sizes and require an attached connector or a portal for a connector to be attached or a method thereof. Specific ornamental pendant designs include, but are not limited to: Tattoos, Messages, Photos, Charms, Logos, Promotional, Advertising, Collectable, Informational and Limited Editions.

Those skilled in the art that yet other modifications could be made to the provided invention without deviating from its spirit and scope as so claimed will therefore appreciate it.

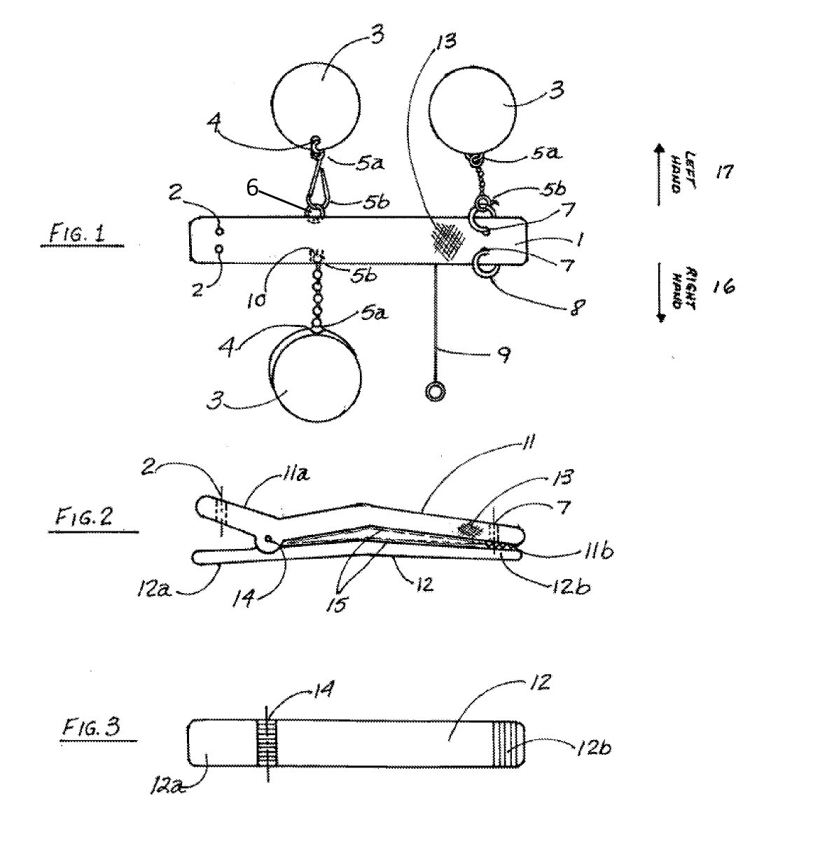

FIG. 1 shows a general view of the upper clip member. Pendants 3 and attachments 5a and 5b are shown for both right hand 16 and left hand 17 options. Holding the clip in a manner where the upper clip member pinching portion 11a is viewed from the top and pointed inward and the upper clip member gripping portion 11b is pointed outward, the wearer can determine the direction the pendants will hang when attached.

Post receptacles 2 FIGS. 1 & 2 through pinching portion of upper clip member allow for the attachment of stud and post earrings, pendants, or other attachments as desired.

A detachable pendant 3 with a connector assembly 5 that is permanently attached to the pendant 5a with an attaching mechanism detachable from the upper clip member 5b or another manner that keeps the spirit of the design, permits the simple addition or removal of pendants and the like to the clip. Various clip connecting devices 6, 9 & 10 are permanently attached to the upper clip member and may vary in style, size and quantity depending on the size of the clip and the number of pendants clip is intended to accept. The hole(s) 7 FIGS. 1 & 2 for attaching a ring connecting device 8 may vary in size and number depending on the size of the clip and the number of pendants it is intended to accept.

FIG. 2 show the lower clip member 12 with the pinching portion 12a and the gripping portion 12b. The resilient member: pivot pin and coil spring assembly are critical to the success of this invention. The resilient member must be strong enough to securely clasp thick material such as a baseball cap brim and small enough to maintain the compact design of the invention so it can be clipped on more delicate articles such as camisole straps and bra straps. Synthetic polymer material coating 13 will be applied to exposed surfaces of clip body to protect clothing and skin. Synthetic polymer material padding 15 will be applied along the length of the interior surfaces between resilient member and gripping surface to protect clothing and prevent slippage.

1-2. (canceled)

3. A decorative item, comprising:
a longitudinally extending clip comprising:
a lower clip member;
an upper clip member pivotally coupled to said lower clip member through a pivot pin; and,
a spring disposed about said pivot pin and biasing said upper clip member to a first position relative to said lower clip member;
a first clip connecting device of a first type disposed on said upper clip member and configured to receive a first pendant; and,
a second clip connecting device of a second type, different from said first type, disposed on said upper clip member and configured to receive a second pendant.

4. The decorative item of claim 3 wherein said upper clip member includes a pinching portion and a gripping portion, said first clip connecting device formed in said pinching portion and said second clip connecting device formed in said gripping portion.

5. The decorative item of claim 3 wherein said upper and lower clip members are coated with a synthetic polymer material.

6. The decorative item of claim 3, further comprising padding comprising a synthetic polymer material, said padding covering a surface of said lower clip member and a surface of said upper clip member facing said surface of said lower clip member.

7. The decorative item of claim 3 wherein said first clip connecting device comprises a post receptacle and said second clip connecting device comprises a ring extending through a hole in said upper clip member.

8. The decorative item of claim 3, further comprising a third clip connecting device of said first type and a fourth clip connecting device of said second type, said first and second clip connecting devices disposed nearer to a first lateral edge of said upper clip member than a second lateral edge of said upper clip member, said third and fourth clip connecting devices disposed nearer to said second lateral edge than said first lateral edge.

9. A decorative item, comprising:
a longitudinally extending clip comprising:
a lower clip member;
an upper clip member pivotally coupled to said lower clip member through a pivot pin;
a spring disposed about said pivot pin and biasing said upper clip member to a first position relative to said lower clip member;
a first clip connecting device of a first type disposed on said upper clip member and configured to receive a first pendant;
a second clip connecting device of a second type, different from said first type, disposed on said upper clip member and configured to receive a second pendant.
a third clip connecting device of said first type; and
a fourth clip connecting device of said second type,
wherein said first and second clip connecting devices are disposed nearer to a first lateral edge of said upper clip member than a second lateral edge of said upper clip member and said third and fourth clip connecting devices are disposed nearer to said second lateral edge than said first lateral edge and a line extending between said first and third clip connecting devices is parallel to a line extending between said second and fourth clip connecting devices.

10. The decorative item of claim 9 wherein said upper clip member includes a pinching portion and a gripping portion, said first clip connecting device formed in said pinching portion and said second clip connecting device formed in said gripping portion.

11. The decorative item of claim 9 wherein said upper and lower clip members are coated with a synthetic polymer material.

12. The decorative item of claim 9, further comprising padding comprising a synthetic polymer material, said padding covering a surface of said lower clip member and a surface of said upper clip member facing said surface of said lower clip member.

13. The decorative item of claim 9 wherein said first clip connecting device comprises a post receptacle and said second clip connecting device comprises a ring extending through a hole in said upper clip member.
